(19) United States
(12) Patent Application Publication
(10) Pub. No.: US 2009/0122093 A1
(43) Pub. Date: May 14, 2009

(54) Fluid Ejection Device, Inkjet Printer and Control Method for Fluid Ejection Device

(75) Inventor: Yoshinori Mutoh, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/795,347

(22) PCT Filed: Dec. 26, 2005
(86) PCT No.: PCT/JP05/23790

§ 371 Date: Jun. 24, 2008

(30) Foreign Application Priority Data
Jan. 14, 2005 (JP) 2005-008047

(51) Int. Cl. B41J 29/38

(52) U.S. Cl. 347/7

(57) ABSTRACT

A printing device (10) includes: an inkjet head (30) ejecting ink to paper (20); a tube (32) supplying ink to the inkjet head (30); an ink tank (36) connected to the tube (32) and storing the ink supplied by the tube (32); a housing (38) housing the ink tank (36); a detection device detecting the volume of the ink tank (36); a regulator adjusting the negative pressure of the space between the ink tank (36) and the housing (38); a pump connected to the regulator for generating a negative pressure having a constant value used by the regulator for adjusting the negative pressure of the space; and a CPU (70) controlling the regulator so that the negative pressure of the space between the ink tank (36) and the housing (38) corresponds to the volume detected by the detection device. Accordingly, the small-sized device can be used to reduce waste of the stored fluid and shorten the takt time.

### TECHNICAL FIELD

The present invention relates to a fluid ejection device, an inkjet printer and a method of controlling a fluid ejection device, and particularly to a fluid ejection device, an inkjet printer and a method of controlling a fluid ejection device controlling a supply system.

### BACKGROUND ART

Japanese Patent Laying-Open No. 4-208469 (Patent Document 1) discloses an inkjet device used for a printer, including a print head having a nozzle, an ink container for storing ink to be supplied to the print head, and a hoisting and lowering device for raising the ink container according to the amount of ink ejected from the nozzle. According to this invention, even when the amount of ink remaining in the ink container decreases, clear printing can be accomplished. Usually, an inkjet printer includes an inkjet head and an ink tank. A pressure acts on the inkjet head. The pressure is a pressure generated due to a difference in height between the ink tank and the inkjet head. For example, when the ink tank is disposed at a higher position than the inkjet head, a positive pressure according to the height difference acts on the inkjet head. When the ink tank is disposed at a lower position than the inkjet head, a negative pressure according to the height difference acts on the inkjet head. In the case where a positive pressure acts on the inkjet head, the ink will flow out from an opening of the nozzle of the inkjet head unless any measures are taken. In the case where a negative pressure acts on the inkjet head, air is sucked from the nozzle opening. A reason why the invention disclosed in Patent Document 1 can provide clear printing even when the amount of ink remaining in the ink container decreases is that the hoisting and lowering device raises the ink container according to the amount of ink ejected from the nozzle and thereby cancels the above-described pressure. A reason why the cancellation of the pressure allows clear printing to be accomplished is that a meniscus (interface between the ink and the air) is generated at the opening of the nozzle.

Japanese Patent Laying-Open No. 2002-248787 (Patent Document 2) discloses a liquid jet device including a liquid bag containing a liquid to be supplied to a liquid ejection head and generating a negative pressure in the liquid ejection head by a difference in height between the liquid ejection head and the liquid bag. The liquid bag has two opposing surfaces having the largest area, one of the surfaces is located toward the direction opposite to the direction of gravity, and at least a part of this surface is fixed while the other surface is freely movable, and the liquid jet device includes a device detecting the amount of liquid remaining in the liquid bag based on the position of the surface located toward the direction of gravity and moving according to the amount of liquid contained in the liquid bag.

According to the invention, a variation of the pressure in the liquid ejection head that is caused by a variation of the amount of liquid in the liquid bag can be reduced. Since the pressure variation can be reduced, the speed of movement of the carriage can be increased. In addition, the amount of unavailable liquid can be reduced.

Japanese Patent Laying-Open No. 2003-300331 (Patent Document 3) discloses an inkjet recording device including: a recording head having a nozzle portion ejecting ink; an ink bag connected to the nozzle portion and containing ink; a sealed container for sealing the ink bag; a suction device for negative-pressure suction of a space between the sealed container and the ink bag; a negative-pressure detection device measuring the pressure of the space between the sealed container and the ink bag; a storage device storing data concerning a predetermined parameter; and a negative-pressure control device operating, based on data read from the storage device, so that the negative-pressure suction by the suction device allows a detected negative pressure value that is detected by the negative-pressure detection device to be a preset target negative pressure value.

According to this invention, the negative pressure of the space between the sealed container and the ink bag can be controlled speedily. A reason why the negative pressure can be controlled speedily is that a set value of the negative pressure or the period of time for which the suction is performed is controlled in advance according to the amount of remaining ink. A reason why the set value or the time is controlled in advance according to the amount of remaining ink is that, if the volume of the space between the sealed container and the ink bag changes depending on the amount of remaining ink, the suction performed for the same period of time produces different negative pressure levels achieved. A reason why different negative pressure levels are achieved is that the amount of suction is different even when suction is done for the same period of time, if the volume of the space between the sealed container and the ink bag changes depending on the amount of remaining ink.

### Patent Document 1: Japanese Patent Laying-Open No. 4-208469

### Patent Document 2: Japanese Patent Laying-Open No. 2002-248787

### Patent Document 3: Japanese Patent Laying-Open No. 2003-300331

### DISCLOSURE OF THE INVENTION

### Problems to be Solved by the Invention

In the case where the hoisting and lowering device is provided that raises the ink container according to the amount of ink ejected from the head as disclosed in Patent Document 1, however, a problem of increase in size and cost of the device arises. Referring to FIG. 6, when a large amount of ink remains in an ink tank 36, ink tank 36 operates to contract. When ink tank 36 operates to contract, a positive pressure acts on the ink in ink tank 36. Referring to FIG. 7, when a small amount of ink remains in ink tank 36, ink tank 36 operates to expand. When ink tank 36 operates to expand, a negative pressure acts on the ink in ink tank 36. FIG. 8 is a chart showing a relation between an amount of ink in ink tank 36 and a negative pressure to be applied to ink tank 36 in order to eject ink in a normal manner by the nozzle of the inkjet head. FIG. 8 shows the following facts. A first fact is that a relatively large negative pressure is necessary when the amount of remaining ink is large (approximately 16 cc or more in the case of FIG. 8). A second fact is that a relatively small negative pressure is necessary when the amount of remaining ink is small (approximately 4.5 cc or less in the case of FIG. 8). Accordingly, the following matters are clearly seen. A first matter is that a larger negative pressure is required to act against the contraction force of ink tank 36 (positive pressure to the head) in the case where a large amount of ink remains. A second matter is that the negative pressure is required to be decreased to act against the expansion force of ink tank 36 (negative pressure to the head) in the case where a small amount of ink remains. Because of these requirements (if no measure is taken for addressing them, the meniscus of the nozzle will be broken, resulting in ink leakage or unsuccessful normal ejection), conventional printers limit the amount of ink contained in ink tank 36 or the amount of ink used for printing. Because of the limitation on the amount of ink, the following problems arose. A first problem is that the interval at which ink tank 36 is replaced or the interval at which ink tank 36 is replenished with ink has to be shortened more than necessary. A second problem is that, supposing that ink tank 36 is replaced, ink tank 36 has to be replaced when the amount of remaining ink becomes smaller than a certain amount, resulting in wasteful consumption of the ink.

The invention disclosed in Patent Document 1 has to move the ink container by a greater distance in order to solve the above-described problems. This is a factor of increase in size of the device.

The invention disclosed in Patent Document 2 has the following problems. A first problem is that the amount of ink disposed of cannot be reduced sufficiently. A second problem is that the amount of ink that can be used for printing is restricted with respect to the capacity of the ink tank (and accordingly the interval at which the ink tank is replaced shortens or the takt time increases). A reason why the amount of ink available for printing is limited is that, when a large amount of ink remains, the ink is difficult to be ejected appropriately.

The invention disclosed in Patent Document 3 has a problem that accurate control of the negative pressure applied to the ink tank is difficult. This is for the reason that the negative pressure for suction and the time for suction are controlled so that the negative pressure applied to the ink tank has a target value.

The present invention has been made for solving the above-described problems. An object of the present invention is to provide a fluid ejection device, an inkjet printer and a method of controlling a fluid ejection device, while waste of stored fluid can be reduced and the takt time can be shortened using the small-sized device.

### Means for Solving the Problems

With the purpose of achieving the above-described object, according to an aspect of the present invention, a fluid ejection device includes: an ejection unit for ejecting a fluid to an object; a tube connected to the ejection unit for supplying the fluid to the ejection unit; a first container connected to the tube for storing the fluid supplied by the tube while elastically deforming according to an amount of the stored fluid; a second container housing the first container; a detection device for detecting a volume of the first container; an adjustment device for adjusting a negative pressure of a space between the first container and the second container; a pump connected to the adjustment device for generating a negative pressure having a constant value used by the adjustment device for controlling the negative pressure of the space; and a control unit for controlling the adjustment device so that the negative pressure of the space between the first container and the second container corresponds to the volume detected by the detection device.

Specifically, the first container stores the fluid to be supplied by the tube while elastically deforming according to the amount of stored fluid. The tube supplies the fluid to the ejection unit. The ejection unit ejects the fluid to the object. The second container houses the first container. The adjustment device uses a negative pressure having a constant value generated by the pump to adjust the negative pressure of the space between the first container and the second container. The detection device detects the volume of the first container. The control unit controls the adjustment device so that the negative pressure of the space between the first container and the second container corresponds to the volume detected by the detection device. Accordingly, regardless of the amount of stored fluid, the pressure exerted on the fluid can be adjusted by the force generated from the elastic deformation of the first container and the negative pressure adjusted by the adjustment device. As the pressure is adjusted, with the small-sized device, waste of the stored fluid due to the force exerted by the first container on the fluid can be reduced. As the waste of fluid can be reduced, the takt time required for storing the fluid can be shortened. In this way, with the small-sized device, the fluid ejection device can be provided while waste of the stored fluid can be reduced and the takt time can be shortened.

Preferably, the adjustment device includes a device for adjusting the negative pressure by opening and closing a valve.

Specifically, the adjustment device uses the negative pressure of a constant value generated by the pump to adjust the negative pressure of the space between the first container and the second container by opening and closing the valve. Thus, the structure for adjusting the negative pressure can be simplified. In this way, with a simply-structured and small-sized device, the fluid ejection device can be provided while waste of the stored fluid can be reduced and the takt time can be shortened.

Preferably, the device for adjusting the negative pressure by opening and closing the valve is a regulator.

Specifically, the regulator uses the negative pressure having a constant value generated by the pump to adjust the negative pressure of the space between the first container and the second container. Thus, leakage of the fluid for example is unlikely to occur. In this way, with the simply-structured and small-sized device, the fluid ejection device can be provided while waste of the stored fluid can be reduced and the takt time can be shortened.

Preferably, the control unit includes a generation unit for generating a signal representing a value corresponding to the volume detected by the detection device. Preferably, the adjustment device includes a device for adjusting the negative pressure so that a magnitude of the negative pressure corresponds to the value represented by the signal.

Specifically, the generation unit generates a signal representing a value corresponding to the volume detected by the detection device. The adjustment device adjusts the negative pressure so that the value represented by the signal corresponds to the magnitude of the negative pressure. Thus, the structure for adjusting the negative pressure can be simplified. In this way, with the simply-structured and small-sized device, the fluid ejection device can be provided while waste of the stored fluid can be reduced and the takt time can be shortened.

Preferably, the fluid ejection device further includes a storage unit for storing in advance first data showing a relation between the volume of the first container and the negative pressure of the space and second data showing a relation between the negative pressure of the space and a value of the signal output by the control unit to the adjustment device. Preferably, the generation unit includes: a first determination unit for determining the negative pressure of the space based on the volume detected by the detection device and the first data; a second determination unit for determining the value of the signal based on the negative pressure of the space determined by the first determination unit and the second data; and a unit generating a signal representing the value determined by the second determination unit.

Specifically, the first determination unit determines the negative pressure of the space based on the volume detected by the detection device and the first data. The second determination unit determines the value of the signal based on the negative pressure of the space determined by the first determination unit and the second data. The unit for generating the signal generates the signal representing the value determined by the second determination unit. Thus, the negative pressure can be adjusted accurately. Since the negative pressure is adjusted accurately, waste of the stored fluid can be reduced reliably. Since the waste is reliably reduced, the takt time can be shortened reliably. In this way, with the simply-structured and small-sized device, the fluid detection device can be provided reliably while waste of the stored fluid can be reduced and the takt time can be shortened.

Preferably, the data stored in the storage unit further includes correction data showing a correction value of the negative pressure of the space corresponding to a density of the fluid. Preferably, the generation unit further includes a correction unit for correcting the negative pressure of the space determined by the first determination unit, based on the correction data. Preferably, the second determination unit includes a unit determining the value of the signal based on the negative pressure of the space corrected by the correction unit and the second data.

Specifically, the correction unit corrects the negative pressure of the space determined by the first determination unit, based on the correction data. The second determination unit determines the value of the signal based on the negative pressure of the space corrected by the correction unit and the second data. Thus, the negative pressure can be adjusted more accurately. In this way, with the simply-structured and small-sized device, the fluid ejection device can be provided more reliable while waste of the stored fluid can be reduced and the takt time can be shortened.

Preferably, the detection device includes: a detection plate moving according to a change of the volume of the first container; a detection bar having one end contacting the detection plate and the other end protruding outside the second container; a pivot shaft supporting the detection bar so that the detection bar is pivotable according to movement of the detection plate; a measurement plate contacting the detection bat on the outside of the second container and moving according to an amount of pivot of the detection bar; and a sensor measuring an amount of movement of the measurement plate.

Specifically, the detection plate moves according to a change in volume of the first container. The detection bar has one end contacting the detection plate and is supported by the pivot shaft. Therefore, the detection bar pivots according to the movement of the detection plate. The measurement plate contacts the end of the detection bar. Therefore, when the detection bar pivots, the measurement plate moves according to the amount of pivot of the detection bar. The sensor measures the amount of movement of the measurement plate. Thus, the structure for detecting the volume of the first container can be simplified. In this way, with the simply-structured and small-sized device, the fluid ejection device can be provided while waste of the stored fluid can be reduced and the takt time can be shortened.

Preferably, the pump is a vacuum pump.

Preferably, the pump is an ejector capable of generating a negative pressure having a constant value by applying a specified positive pressure.

Preferably, the fluid ejection device further includes a shutoff valve located between opposite ends of the tube and closing when supply of electric power to the fluid ejection device is stopped.

Specifically, the shutoff valve is located anywhere between the opposite ends of the tube and closes when electric power supply to the fluid ejection device is stopped. Thus, as compared with the case where the shutoff valve is not provided, waste of the stored fluid is further reduced. In this way, with the small-sized device, the fluid ejection device can be provided while waste of the stored fluid can be further reduced and the takt time can be shortened.

According to another aspect of the present invention, an inkjet printer includes the fluid ejection device as described above.

Specifically, with the small-sized device, the ink jet printer can be provided while waste of the stored fluid can be reduced and the takt time can be shortened.

According to still another aspect of the present invention, a method of controlling a fluid ejection device is a method of controlling the fluid ejection device including: an ejection unit for ejecting a fluid to an object; a tube connected to the ejection unit for supplying the fluid to the ejection unit; a first container connected to the tube for storing the fluid supplied by the tube while elastically deforming according to an amount of the stored fluid; a second container housing the first container; a detection device for detecting a volume of the first container; an adjustment device for adjusting a negative pressure of a space between the first container and the second container; a pump connected to the adjustment device for generating a negative pressure having a constant value used by the adjustment device for controlling the negative pressure of the space; a control unit for controlling the adjustment device so that the negative pressure of the space between the first container and the second container corresponds to the volume detected by the detection device; and a storage unit for storing in advance first data showing a relation between the volume of the first container and the negative pressure of the space and second data showing a relation between the negative pressure of the space and a value of a signal output by the control unit to the adjustment device. The control method includes: a first determination step of determining by the control unit the negative pressure of the space based on the volume detected by the detection device and the first data; a second determination step of determining by the control unit the value of the signal based on the negative pressure of the space determined in the first determination step and the second data; a step of generating a signal representing the value determined in the second determination step; an output step of outputting the signal generated in the step of generating the signal; and an adjustment step of adjusting by the adjustment device the negative pressure of the space between the first container and the second container so that a magnitude of the negative pressure corresponds to the value represented by the signal.

Specifically, with the small-sized device, the method can be provided of controlling the fluid ejection device while waste of the stored fluid can be reduced and the takt time can be shortened.

### EFFECTS OF THE INVENTION

According to the fluid ejection device, the inkjet printer and the control method for the fluid ejection device, waste of the stored fluid can be reduced and the takt time can be shortened using the small-sized device.

### BRIEF DESCRIPTION OF THE DRAWINGS

FIG. 1 is an entire configuration diagram of a printing device according to an embodiment of the present invention.

FIG. 2 is an entire configuration diagram of a suction device according to the embodiment of the present invention.

FIG. 3 is a chart showing a relation between a magnitude of a negative pressure acting on an ink tank and a value of an output signal of a computer according to the embodiment of the present invention.

FIG. 4 is a flowchart showing a control procedure for setting a negative pressure according to the embodiment of the present invention.

FIG. 5 is a chart showing a relation between a density of ink and a value of a negative pressure according to the embodiment of the present invention.

FIG. 6 is a conceptual diagram showing that an ink tank exerts a positive pressure on ink.

FIG. 7 is a conceptual diagram showing that the ink tank exerts a negative pressure on ink.

FIG. 8 is a chart showing a relation between an amount of remaining ink stored in an ink tank and a magnitude of a negative pressure applied for appropriately ejecting ink.

### DESCRIPTION OF THE REFERENCE SIGNS

10 printing device, 12 computer, 14 carriage, 16 suction device, 20 paper, 30 inkjet head, 32 tube, 34 shutoff valve, 36 ink tank, 38 housing, 40 detection plate, 42 detection bar, 44 pivot shaft, 46 measurement plate, 48 position sensor, 60 vacuum pump, 62 air tube, 64 regulator, 70 CPU, 72 memory

### BEST MODES FOR CARRYING OUT THE INVENTION

In the following, embodiments of the present invention will be described with reference to the drawings. In the following description, like components are denoted by like reference characters. They are named and function identically as well. Therefore, a detailed description thereof will not be repeated.

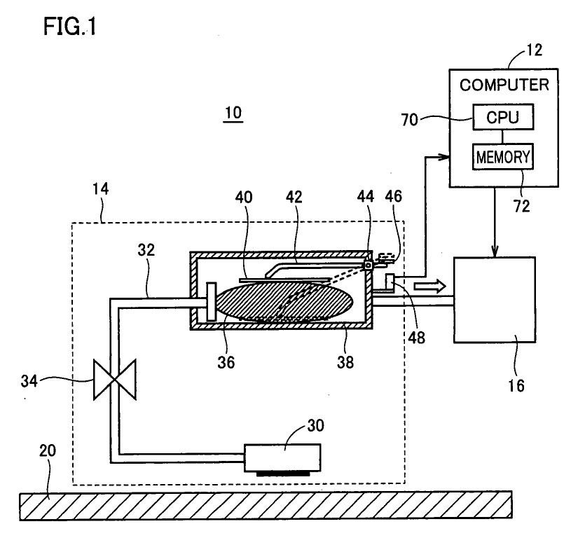

Referring to FIG. 1, a printing device 10 according to the present embodiment includes a computer 12, a carriage 14 and a suction device 16. In the present embodiment, printing device 10 is included in an inkjet printer. Computer 12 controls each component of printing device 10. Computer 12 is also a device performing an operation necessary for controlling printing device 10. Carriage 14 is a device for ejecting ink to an arbitrary position of paper 20 under control by computer 12. Carriage 14 is moved by a drive device (not shown) along a recording surface of paper 20. Suction device 16 is a device exerting a negative pressure on the ink ejected by carriage 14. Since the negative pressure is exerted, leakage of ink from carriage 14 is prevented.

Carriage 14 includes an inkjet head 30, a tube 32, a shutoff valve 34, an ink tank 36, a housing 38, a detection plate 40, a detection bar. 42, a pivot shaft 44, a measurement plate 46, and a position sensor 48. Inkjet head 30 ejects a fluid (ink in the present embodiment) to an object (paper 20 in the present embodiment) while adjusting the amount of ink. In this way, carriage 14 ejects ink to an arbitrary position of paper 20. Tube 32 is connected to inkjet head 30 for supplying ink to inkjet head 30. Shutoff valve 34 closes when electric power supply to printing device 10 is stopped. Thus, ink leakage is prevented. Shutoff valve 34 is disposed at any position between the opposite ends of tube 32. In the present embodiment, shutoff valve 34 is a normally close valve. Shutoff valve 34 opens only while electric power is supplied. When electric power supply to printing device 10 is stopped, shutoff valve 34 closes. Thus, when electric power supply to printing device 10 is stopped, leakage of ink is prevented. Ink tank 36 is connected to tube 32 for storing ink supplied from tube 32 while elastically deforming according to the amount of stored ink. In the present embodiment, ink tank 36 is a flexible bag-shaped container. In the present embodiment, ink tank 36 is a vinyl bag. Ink tank 36 is disposed at a higher position than inkjet head 30. Thus, ink tank 36 can use the height difference (in the present embodiment, the height difference is supposed to be 30 cm) to supply ink to inkjet head 30. Housing 38 is a case housing ink tank 36. Housing 38 is highly air-tight and thus expansion and contraction thereof can be ignored. Detection plate 40 is a thin plate provided on ink tank 36. Thus, detection plate 40 moves according to a change of the volume of ink tank 36. Detection bar 42 is a component for communicating the position of detection plate 40 (and thus the amount of ink stored in ink tank 36) to measurement plate 46. Detection bar 42 has one end contacting detection plate 40 and the other end protruding on the outside of housing 38. Pivot shaft 44 is a shaft supporting detection bar 42 so that detection bar 42 can pivot according to movement of detection plate 40. Measurement plate 46 is disposed on the outside of housing 38, contacts detection bar 42 and moves according to the amount of pivot of detection bar 42. Position sensor 48 measures an amount of movement of measurement plate 46 (and thus the amount of ink stored in ink tank 36). In the present embodiment, detection plate 40, detection bar 42, pivot shaft 44, measurement plate 46, and position sensor 48 constitute one detection device for detecting the volume of ink tank 36. In the following description, the device including detection plate 40, detection bar 42, pivot shaft 44, measurement plate 46 and position sensor 48 is referred to as “detection device.”

Computer 12 includes a CPU (Central Processing Unit) 70 and a memory 72. CPU 70 serves as a circuit determining a value based on data stored in memory 72. CPU 70 also serves as a circuit performing an operation based on data stored in memory 72 or input data. CPU 70 also serves as a circuit generating a signal for control (for example, a signal representing a value corresponding to the volume detected by the detection device). CPU 70 also serves as a circuit outputting the signal generated by itself Thus, each component of printing device 10 is controlled. CPU 70 also serves as a circuit performing an operation based on data stored in memory 72 or input data. Memory 72 stores a value of the negative pressure to be exerted with respect to each ink density. Memory 72 is also a storage device storing data necessary for control of printing device 10 by CPU 70.

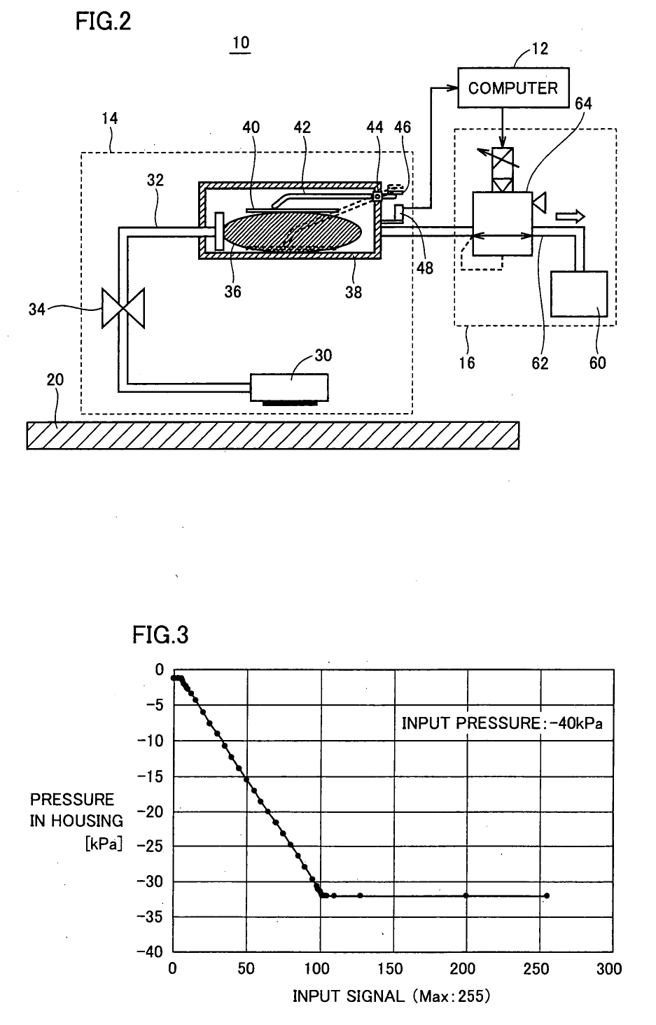

Referring to FIG. 2, suction device 16 includes a vacuum pump 60, an air tube 62 and a regulator 64. Vacuum pump 60 is connected to regulator 64 for generating a negative pressure having a constant value used by regulator 64 to adjust the negative pressure of the space. Air tube 62 is a tube directing air in housing 38 to vacuum pump 60. Regulator 64 adjusts the negative pressure of the space between ink tank 36 and housing 38 by opening and closing the valve. Regulator 64 in the present embodiment adjusts the magnitude of the negative pressure acting on ink tank 36 so that the magnitude of the negative pressure corresponds to a value of the output signal of CPU 70. FIG. 3 is a chart showing a relation between the magnitude of the negative pressure acting on ink tank 36 and the value of the output signal of CPU 70. In the present embodiment, the magnitude of the negative pressure (input pressure) exerted by vacuum pump 60 on ink tank 36 is −40 kilopascals. In the present embodiment, regulator 64 has a resolution of 0.3 kPa. When the negative pressure exerted by vacuum pump 60 is different, the saturation pressure (corresponding to the position of the horizontal portion of the line in FIG. 3) changes. It should be noted that the absolute value of the negative pressure exerted by vacuum pump 60 has to be a value or less that is determined by the specifications of regulator 64. If the absolute value of the negative pressure exceeds the value determined by the specifications, adjustments have to be made so that the negative pressure applied to regulator 64 is within the range determined by the specifications. A method of adjustment is to provide another regulator between vacuum pump 60 and regulator 64. In the present embodiment, regulator 64 has a D/A (Digital-to-Analog) converter incorporated therein. The D/A converter converts an output signal (digital signal) of CPU 70 into an analog signal that can be used for controlling the negative pressure.

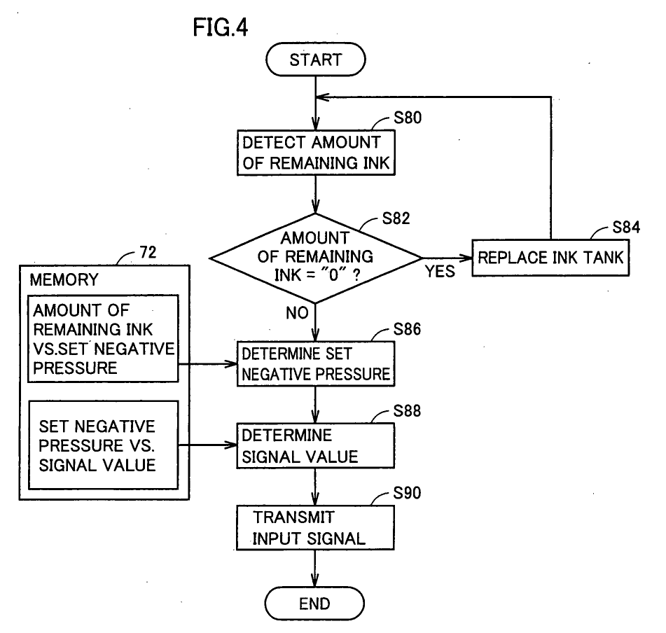

Referring to FIG. 4, a program executed by printing device 10 has a control structure regarding negative-pressure setting as described below.

In step 80 (hereinafter “step” is abbreviated as S), position sensor 48 detects the position of measurement plate 46 and thereby detects the amount of remaining ink stored in ink tank 36. When the amount of remaining ink is detected, position sensor 48 outputs a signal representing the amount of remaining ink to CPU 70.

In S82, CPU 70 determines whether the amount of remaining ink stored in ink tank 36 is “0” or not. When it is determined that the amount of remaining ink is “0” (YES in S82), the procedure proceeds to S84. Otherwise (NO in S82), the procedure proceeds to S86.

In S84, CPU 70 outputs a signal to a display device (not shown). The display device receiving the signal from CPU 70 displays a message that ink tank 36 should be replaced. Using a sensor (not shown), CPU 70 detects whether replacement of ink tank 36 is completed or not. Until the replacement of ink tank 36 is completed, CPU 70 regularly detects whether replacement of ink tank 36 is completed or not.

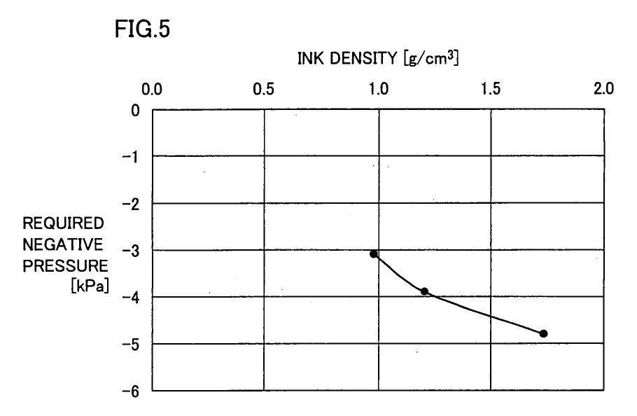

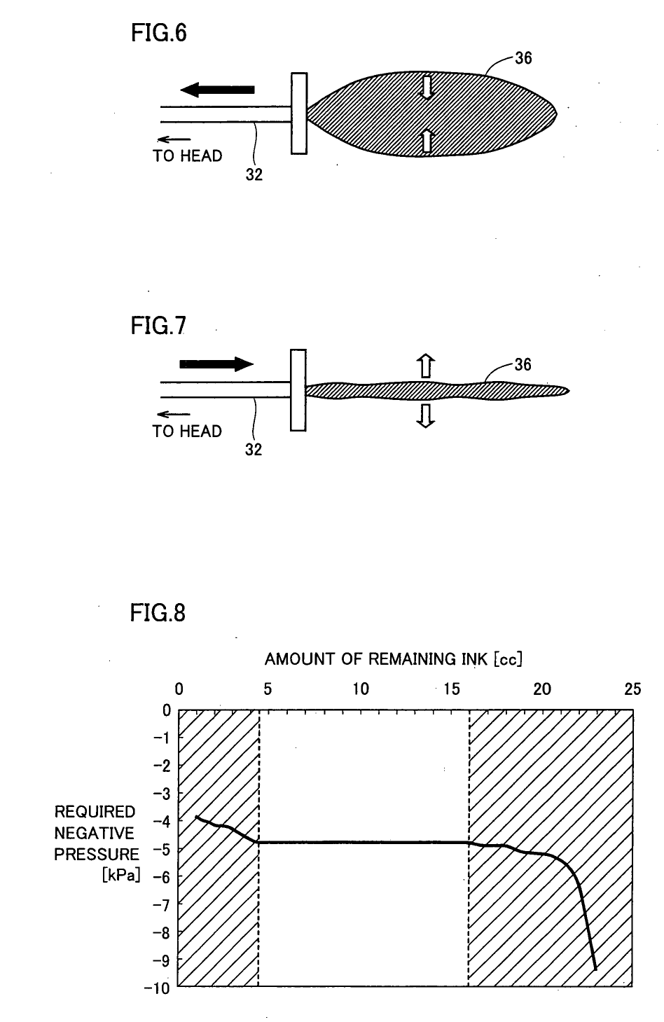

In S86, CPU 70 determines the negative pressure of the space, based on the volume detected by the detection device (volume of ink tank 36) and first data (first data refers to data representing a relation between the volume of the ink tank and the negative pressure of the space (referring to the space between ink tank 36 and housing 38 in the present embodiment), and the first data is stored in advance in memory 72). When the negative pressure is determined, CPU 70 corrects the negative pressure of the space as determined by itself, based on correction data (correction data refers to data representing a correction value for the negative pressure of the space, associated with the ink density, and the correction data is also stored in memory 72). FIG. 5 is a chart showing details of the correction data (relation between the ink density and the value of the negative pressure acting on ink tank 36). In the present embodiment, computer 12 corrects the negative pressure of the space so that the absolute value of the negative pressure acting on the ink increases as the ink density increases. Without this control, the negative pressure of a magnitude more than necessary could be exerted on the ink to cause inkjet head 30 to suck the air, or the magnitude of the negative pressure is insufficient to cause the ink to leak from inkjet head 30.

In S88, CPU 70 determines a value of the signal to be output to regulator 64 based on the negative pressure of the space corrected by itself and second data (second data refers to data representing a relation between the negative pressure of the space and the value of the signal to be output to regulator 64 by CPU 70, and the second data is also stored in advance in memory 72).

In S90, CPU 70 generates a signal representing the value determined by itself in S88. When the signal value is determined, CPU 70 outputs the generated signal to regulator 64. When the signal is output, regulator 64 adjusts the negative pressure of the space between ink tank 36 and housing 38 so that the magnitude of the negative pressure corresponds to the value represented by the signal. Vacuum pump 60 exerts the negative pressure on ink tank 36.

A description will be given of operation of printing device 10, based on the above-described structure and flowchart.

Position sensor 48 detects the amount of remaining ink stored in ink tank 36 (S80). When the amount of remaining ink is detected, CPU 70 determines whether the amount of remaining ink is “0” or not (S82). If the amount of remaining ink is not “0” (NO in S82), CPU 70 determines the negative pressure of the space based on the volume detected by the detection device and the first data. As described above in connection with FIG. 8, if a large amount of ink remains, a relatively great negative pressure is required. If a small amount of ink remains, a relatively small negative pressure is required. Thus, according to the amount of remaining ink, the negative pressure of the space between ink tank 36 and housing 38 has to be controlled. This is a reason why the magnitude of the negative pressure is determined. When the negative pressure is determined, CPU 70 corrects the negative pressure of the space determined by itself, based on the correction data (S86). When the negative pressure is corrected, CPU 70 determines the value of the signal to be output to regulator 64, based on the negative pressure of the space corrected by itself in S86 and the second data (S88). When the signal value is determined, CPU 70 generates a signal representing the value determined by itself in S88. When the signal value is determined, CPU 70 outputs the generated signal to regulator (S90). In this way, CPU 70 controls regulator 64 so that the negative pressure of the space between ink tank 36 and housing 38 corresponds to the volume detected by the detection device.

As heretofore described, the printing device of the present embodiment can control, based on the data stored in advance, the negative pressure exerted on the ink tank according to the amount of remaining ink stored in the ink tank. Since the negative pressure is controlled, almost all of the ink stored in the ink tank can be used for printing. Since almost all of the ink can be used for printing, replacement of the ink tank can be postponed or the interval at which the ink tank is replenished with ink can be increased. Since almost all of the ink can be used for printing, the amount of the ink disposed of can be reduced. Since the negative pressure is controlled, leakage of ink from the nozzle or suction of air by the nozzle can be avoided. Since the negative pressure is controlled based on the data stored in advance, the negative pressure can be controlled efficiently. The printing device of the present embodiment uses the vacuum pump generating the negative pressure of a constant value and uses the regulator to control the negative pressure acting on the ink tank. Thus, the negative pressure to be exerted on the ink tank can be controlled accurately by the low-cost, simply-configured and small-sized device. The printing device of the present embodiment uses the position sensor capable of detecting a subtle positional change. Thus, the amount of ink remaining in the ink tank can be detected correctly. Since the amount of remaining ink is correctly detected, the negative pressure can be controlled with high precision. The printing device of the present embodiment controls the negative pressure to be exerted on the ink tank according to the ink density. Thus, leakage of ink and suction of air (these occur due to a difference between the actual ink density and a supposed ink density) can be avoided. The shutoff valve of the present embodiment closes when the power supply is stopped. Thus, leakage of ink is prevented. Accordingly, the low-cost, simply-configured and small-sized device can be used to provide an inkjet printer with which waste of stored ink can be reduced and the takt time can be shortened.

Further, printing device 10 may be a fluid ejection device used for other purposes. Examples of the fluid ejection device include a device forming a circuit and interconnections on a substrate, a device forming a color filter on a substrate and a device painting a product for example.

Further, printing device 10 may use any apparatus instead of computer 12 for controlling the device adjusting the negative pressure. An example of such an apparatus is a circuit configured with a transistor for example. In this case, an output signal of position sensor 48 is merely amplified and then output to regulator 64.

Furthermore, printing device 10 may use, instead of vacuum pump 60, an ejector that can generate the negative pressure having a constant value by applying a specified positive pressure. Accordingly, as compared with the case where vacuum pump 60 is used, the space can be reduced.

Furthermore, it is desirable that the distance between pivot shaft 19 and an end of detection bar 42 that contacts measurement plate 46 is as long as possible. As this distance is longer, the amount of movement of measurement plate 46 relative to the amount of movement of detection plate 40 is larger. Since the amount of movement of measurement plate 46 is larger, a change of the volume of ink tank 36 can be detected with high sensitivity. This is the reason why the above-described distance should be made longer.

Furthermore, in S86, CPU 70 may not necessarily correct, based on the correction data, the negative pressure of the space that is determined by the CPU itself In the case where the negative pressure of the space is not corrected in S88, CPU 70 determines the value of the signal to be output to regulator 64, based on the uncorrected negative pressure of the space that is determined by the CPU itself as well as the second data.

Embodiments herein disclosed are to be construed as illustrative in all respects, not as restrictive. The scope of the present invention is defined by claims, not by the description above, and it is intended that the scope of the invention includes all modifications equivalent in meaning and scope to claims.

### INDUSTRIAL APPLICABILITY

As heretofore described, in accordance with the present invention, the small-sized device can be used to reduce the waste of the stored fluid and shorten the takt time, and thus the invention is applicable advantageously to industries involved in manufacturing a device for ejecting a fluid and manufacturing a printer, for example.

1: A fluid ejection device comprising:
an ejection unit for ejecting a fluid to an object;
a tube connected to said ejection unit for supplying said fluid to said ejection unit;
a first container connected to said tube for storing said fluid supplied by said tube while elastically deforming according to an amount of said stored fluid;
a second container housing said first container;
a detection device for detecting an amount of said fluid stored in said first container;
an adjustment device for adjusting a negative pressure of a space between said first container and said second container;
a pump connected to said adjustment device for generating a negative pressure having a constant value used by said adjustment device for controlling the negative pressure of the space; and
a control unit for controlling said adjustment device so that the negative pressure of the space between said first container and said second container corresponds to the amount of said fluid detected by said detection device.

2. The fluid ejection device according to claim 1, wherein
said adjustment device includes a device for adjusting the negative pressure by opening and closing a valve.

3. The fluid ejection device according to claim 2, wherein
said device for adjusting the negative pressure by opening and closing the valve is a regulator.

4. The fluid ejection device according to claim 1, wherein
said detection device includes a device for detecting the amount of said fluid stored in said first container by detecting a volume of said first container,
said control unit includes a generation unit for generating a signal representing a value corresponding to the volume detected by said detection device, and
said adjustment device includes a device for adjusting said negative pressure so that a magnitude of the negative pressure corresponds to the value represented by said signal.

5. The fluid ejection device according to claim 4, further comprising a storage unit for storing in advance first data showing a relation between the volume of said first container and the negative pressure of the space and second data showing a relation between said negative pressure of the space and a value of the signal output by said control unit to said adjustment device, wherein
said generation unit includes:
a first determination unit for determining the negative pressure of the space based on the volume detected by said detection device and said first data;
a second determination unit for determining the value of said signal based on the negative pressure of the space determined by said first determination unit and said second data; and
a unit generating a signal representing the value determined by said second determination unit.

6. The fluid ejection device according to claim 5, wherein
the data stored in said storage unit further includes correction data showing a correction value of said negative pressure of the space corresponding to a density of said fluid,
said generation unit further includes a correction unit for correcting the negative pressure of the space determined by said first determination unit, based on said correction data, and
said second determination unit includes a unit determining the value of said signal based on the negative pressure of the space corrected by said correction unit and said second data.

7. The fluid ejection device according to claim 1, wherein
said detection device includes:
a detection plate moving according to a change of the amount of said fluid stored in said first container;
a detection bar having one end contacting said detection plate and the other end protruding outside said second container;
a pivot shaft supporting said detection bar so that said detection bar is pivotable according to movement of said detection plate;
a measurement plate contacting said detection bar on the outside of said second container and moving according to an amount of pivot of said detection bar; and
a sensor measuring an amount of movement of said measurement plate.

8. The fluid ejection device according to claim 1, wherein
said pump is a vacuum pump.

9. The fluid ejection device according to claim 1, wherein
said pump is an ejector capable of generating a negative pressure having a constant value by applying a specified positive pressure.

10. The fluid ejection device according to claim 1, further comprising a shutoff valve located between opposite ends of said tube and closing when supply of electric power to said fluid ejection device is stopped.

11. An inkjet printer comprising the fluid ejection device as recited in claim 1.

12. A method of controlling a fluid ejection device,
said fluid ejection device including:
an ejection unit for ejecting a fluid to an object;
a tube connected to said ejection unit for supplying said fluid to said ejection unit;
a first container connected to said tube for storing said fluid supplied by said tube while elastically deforming according to an amount of said stored fluid;
a second container housing said first container;
a detection device for detecting a volume of said first container;
an adjustment device for adjusting a negative pressure of a space between said first container and said second container;
a pump connected to said adjustment device for generating a negative pressure having a constant value used by said adjustment device for controlling the negative pressure of the space;
a control unit for controlling said adjustment device so that the negative pressure of the space between said first container and said second container corresponds to the volume detected by said detection device; and
a storage unit for storing in advance first data showing a relation between the volume of said first container and the negative pressure of the space and second data showing a relation between said negative pressure of the space and a value of a signal output by said control unit to said adjustment device, and
said method comprising:
a first determination step of determining by said control unit the negative pressure of the space based on the volume detected by said detection device and said first data;
a second determination step (of determining by said control unit the value of said signal based on the negative pressure of the space determined in said first determination step sand said second data;
a step of generating a signal representing the value determined in said second determination step;
an output step of outputting the signal generated in said step of generating said signal; and
an adjustment step of adjusting by said adjustment device the negative pressure of the space between said first container and said second container so that a magnitude of the negative pressure corresponds to the value represented by said signal.
